(19) United States
(12) Patent Application Publication
(10) Pub. No.: US 2011/0052655 A1
(43) Pub. Date: Mar. 3, 2011

(54) METHODS AND VESICLES FOR CONTROLLING PROTOZOA

(76) Inventors: Wilson Kurt WHITEKETTLE, Jamison, PA (US); Gloria Jean Tafel, Doylestown, PA (US); Dorothy G. Reynolds, North Wales, PA (US); Paul Robert Frail, Cherry Hill, NJ (US); Linna Wang, Shanghai (CN); Juan Jiang, Shanghai (CN); Qing Zhao, Kalmar (SE)

(21) Appl. No.: 12/843,850

(22) Filed: Jul. 26, 2010

Related U.S. Application Data
(63) Continuation-in-part of application No. 11/835,717, filed on Aug. 8, 2007, now Pat. No. 7,785,478.

(51) Int. Cl. A01N 25/34; A01N 59/00; A01N 59/08; A01N 59/16; A01N 59/20; A01N 63/02; A01N 63/00; A01N 65/00

(52) U.S. Cl. 424/408; 424/452; 424/616; 424/661; 424/665; 424/618; 424/637; 424/722; 424/650; 424/94.1; 514/4.4; 514/44 R; 424/93.4; 424/93.1; 424/725; 424/450; 424/420

(57) ABSTRACT

A method for controlling protozoa trophozoites and cysts wherein one or more biocides or non-biocidal agents are encapsulated within a micro-capsule or nano-capsule and then introduced into an aqueous system. The micro-capsule or nano-capsule has an exterior composition adapted for digestion by the protozoa. A vesicle for controlling protozoa trophozoites and cysts is also provided.

### CROSS-REFERENCE TO RELATED APPLICATIONS

This application is a continuation-in-part application of U.S. patent application Ser. No. 11/835,717 filed Aug. 8, 2007. The entire contents of U.S. patent application Ser. No. 11/835,717 are incorporated herein by reference.

### FIELD OF THE INVENTION

This invention relates to methods and vesicles for controlling protozoa and more particularly, to methods and vesicles for use in a targeted delivery for controlling protozoa trophozoites and cysts in aqueous systems.

### BACKGROUND OF THE INVENTION

Aqueous systems, such as water distribution systems, cooling towers, showers, aquaria, sprinklers, spas or cleaning baths, can contain protozoa and some types of protozoa can be harmful, causing pathogenic protozoa infections, such as amoebic dysentery, malaria, Giardiasis, Trichomoniasis or Cryptosporidiosis. Other types of protozoa can harbor harmful bacteria that live within the protozoa, grow symbiotically or parasitically within the host cells, and not be killed or inhibited by the host cell. These parasites have developed ways of interacting and overcoming the host cells natural defense mechanisms. Legionella pneumophila, a bacterium known to cause Legionnaire's Disease and Pontiac fever in humans is a parasite of this type. Two protozoa species capable of harboring infectious Legionella are Acanthamoeba and Tetrahymena.

Protozoa are natural grazers on surfaces and engulf and digest bacteria as part of their natural life cycle. Legionella are often found in biofilms adsorbed to solid surfaces in aqueous systems. In most cases, the protozoa digest these bacteria through the use of digestive enzymes in their phagosomes (digestive vacuoles). In the case of Legionella, however, this is not the case. The protozoa are not readily capable of degrading the engulfed Legionella cells, and in fact, the Legionella grow and increase their numbers while protected within protozoa phagosomes. Legionellosis in humans can be contracted by breathing Legionella aerosols containing either the free-living bacterial cells or by inhaling aerosols of Legionella concentrated within susceptible protozoa. Pathogens, such as Legionella cells, and protozoa can be killed with certain chemical agents and antibiotics. However, some protozoa, particularly amoeboid forms, have evolved mechanisms for surviving in hostile environments. Examples of hostile environments are high temperature, desiccation, presence of chemical agents/antibiotics, lack of food sources, etc. Upon encountering a hostile environment, these protozoa revert to a cyst form that is very difficult to kill or contain. The cyst form becomes much less susceptible to chemical agents that readily kill the same organism when it is in non-cyst (trophozoite) form. Introduction of a chemical control agent to eliminate these types of protozoa, such as Acanthamoeba or Tetrahymena, can trigger the protozoa to revert to a cyst form, thereby rendering it invulnerable to the chemical agent. When the cyst contains the pathogen Legionella, the chemical agent can no longer reach the engulfed bacteria, and the chemical treatment is rendered ineffective.

As an example, chlorination or bleach can be used to control Legionella in water distribution systems. Exposed Legionella are readily killed by low levels of free chlorine (0.2-0.5 μg/ml). Infective Legionella can also be contained in Acanthamoeba phagosomes if those protozoa are present. The Acanthamoeba, sensing the chlorine presence, reverts to a cyst form, inadvertently preserving and protecting the Legionella parasites engulfed within it. The Acanthamoeba cysts treated with >500 times (>100 μg/ml “free” chlorine) the concentration needed to kill the trophozoite forms are not killed in the cyst form.

Currently, there are no known cyst deactivating agents in commercial use at this time. Although control agents, which can kill or treat the Legionella bacteria are known, there is no method currently in use which provides for the means to effectively introduce control agents into the aqueous systems where the Legionella bacteria and Legionella harboring protozoa reside. Control agents that control the Legionella harboring protozoa and protozoan cysts provide a much needed additional tool to safeguard the health of workers and the public against the respiratory pneumonias which can result from inhalation of Legionella or Legionella-containing protozoa cysts.

For example, U.S. Pat. No. 6,579,859 discloses the use of phosphonium salts of the general formula (R₁)₃P⁺R₂.X⁻ wherein R₁ is an alkyl group of from 1 to 8 carbon atoms, R₂ is an n-alkyl group having 8 to 20 carbon atoms and X is an anion consisting of a halide, sulfate, nitrate, nitrite, etc.

U.S. Patent Publication No. 2005/002710 teaches the exposure of the protozoa to quaternary ammonium salts, while U.S. Patent Publication No. 2005/0080142 discloses the use of guanidine or biguanidine salts to control Legionella type bacteria in the free-living state as well as when engulfed in the trophozoite form or Acanthamoeba in cyst form.

However, the method of introducing control agents to protozoa has been a barrier, particularly for commercial use. What is needed is a way of controlling protozoa that is efficient and effective, and will be of commercial use.

### SUMMARY OF THE INVENTION

An embodiment of the present invention comprises a method for controlling protozoa trophozoites and cysts wherein one or more biocides or non-biocidal agents are encapsulated within a micro-capsule or nano-capsule having an exterior composition adapted for digestion by said protozoa and then introduced into an aqueous system.

In another embodiment, a vesicle for controlling protozoa trophozoites and cysts, wherein said vesicle contains an exterior composition adapted for digestion by said protozoa and one or more biocides or non-biocidal agents, wherein the biocides or non-biocidal agents are encapsulated within the vesicle and said vesicle is selected from the group consisting of micro-capsule, nano-capsule and liposome.

According to another embodiment of the invention, liposomes are manufactured with a biocide or non-biocidal agent contained within the aqueous liposome core or within the hydrophobic liposome membrane, and then these liposomes are introduced into an aqueous system to control protozoa trophozoites or cysts.

The various features of novelty that characterize the invention are pointed out with particularity in the claims annexed to and forming a part of this disclosure. Changes to and substitutions of the various components of the invention can, of course, be made.

The invention resides as well in sub-combinations and sub-systems of the elements described, and in methods of using them.

### DETAILED DESCRIPTION OF THE INVENTION

While the present invention is described with references to illustrative examples and preferred embodiments, various changes or substitutions may be made on these embodiments by those ordinarily skilled in the art pertinent to the present invention without departing from the technical scope of the present invention. Therefore, the technical scope of the present invention encompasses not only those embodiments described above, but also all that fall within the scope of the appended claims.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The present invention relates to methods for controlling protozoa trophozoites and cysts in aqueous systems. Applicants' realization underlying the invention is for the introduction of a biocide or non-biocidal agent that would appear benign to the protozoa and induce them to excyst or revert back to an active trophozoite form. In an alternate embodiment, since pathogens, such as the Legionella bacteria may be engulfed and protected within the phagosomes of the protozoa, a biocide or non-biocidal agent must be placed inside the protozoa, in close proximity to the Legionella cells without causing the protozoa to grow into a cyst stage. “Biocides” is intended to include, but not be limited to, biocides, biocide compositions, killing agents, control agents, and combinations thereof. “Non-biocidal agents” is intended to include, but not be limited to environmentally-friendly agents or compounds that remove or inactivate the protozoa, but do not harm the environment.

One embodiment provides a method for controlling protozoa trophozoites and cysts wherein one or more biocides or non-biocidal agents are encapsulated within a micro-capsule or nano-capsule having an exterior composition adapted for digestion by said protozoa and then introduced into an aqueous system.

Protozoa trophozoites and cysts in aqueous systems may be controlled in any manner that reduces, removes or inactivates the protozoa and its spread to minimize any harmful effects. In one embodiment, the protozoa trophozoites or cysts in the aqueous system may be controlled by killing or removing it. In another embodiment, the protozoa trophozoites or cysts may be controlled by interfering with its life or reproductive cycle to contain it and stop it from spreading.

The protozoa to be controlled may be any type of protozoa within an aqueous system. In one embodiment, the protozoa may be in its trophozoite form or cyst form. In one embodiment, the protozoa trophozoite or cyst contains a pathogen, which has been engulfed by the phagosome in the protozoa vacuole. In another embodiment, the protozoa contains Legionella pneumophila. In another embodiment, the protozoa may be Acanthamoeba or Tetrahymena. In an alternate embodiment, the protozoa may be infection carrying protozoa including, but not limited to, those that result in amoebic dysentery, malaria, Giardiasis, Trichomoniasis, Cryptosporidiosis and other pathogenic protozoa.

A biocide or non-biocidal agent for controlling the protozoa in the aqueous system is encapsulated into a micro-capsule or nano-capsule and added to an aqueous system to control the protozoa trophozoites or cysts. The micro-capsule or nano-capsule has an outer material and shape to mimic bacteria on which the protozoa feeds. The protozoa are tricked into feeding on the micro-capsule or nano-capsule and engulfing it. As the micro-capsule or nano-capsule is digested, the biocide or non-biocidal agent is released and acts on the protozoa. When the protozoa contains pathogens, such as Legionella, the engulfed control agent can act on the protozoa as well as the pathogen inside the protozoa. The microcapsule does not cause the protozoa trophozoite to revert to a cyst stage, as it appears benign to the protozoa. Also, any protozoa in cyst form are induced into an active trophozoite form in order to feed on the micro-capsules or nano-capsules.

The micro-capsule or nano-capsule is a microscopic vesicle or type of structure that encloses a biocide or non-biocidal agent and is for delivering the biocide or non-biocidal agent to the protozoa trophozoites or cysts in an aqueous system. In one embodiment, the micro-capsule or nano-capsule contains the biocide or non-biocidal agent within its core. The micro-capsule or nano-capsule may be produced by any known process and has a similar composition of a microbial membrane and size of a microbial cell and is produced such that it has an exterior composition adapted for digestion by the protozoa. In one embodiment, the micro-capsule or nano-capsule may be prepared from material, such as lecithin, gums, gels, biodegradable or non-biodegradable polymers, such as polylactic acid or polystyrene, organic polymers, combinations of lecithin and organically functionalized lecithin where the functionalization can either be polymer chains, peptides, proteins, lipids, cholesterols or bio receptors. The material may also be multi-block polymers containing hydrophobic and hydrophilic blocks, self-assembled Donor:Acceptor moieties and micelles, inorganic spheres, rods, cages or particles.

The micro-capsules or nano-capsules are produced and applied in any size suitable for grazing on or engulfing by the protozoa. In one embodiment, the micro-capsule or nano-capsule may be from about 0.01 micron to about 100 microns. In another embodiment, the micro-capsule or nano-capsule has a size of from about 0.01 micron to about 50 microns. In another embodiment, the micro-capsule or nano-capsule has a size of from about 0.01 micron to about 20 microns. In another embodiment, the micro-capsule or nano-capsule has a size of from about 0.05 micron to about 15 microns. In another embodiment, the micro-capsule or nano-capsule has a size of from about 0.1 micron to about 10 microns. In another embodiment, the micro-capsule or nano-capsule has a size of from about 0.25 micron to about 2 microns. The size of the micro-capsules or nano-capsules is measured directly by microscopic techniques.

Micro-capsules or nano-capsules can be manufactured by any known process, including, but not limited to, controlled evaporation, extrusion, such as pressure extrusion of an aqueous biocide or non-biocidal agent through a porous membrane into the micro-capsule or nano-capsule body, injection, sonication, microfluid processors and rotor-stator mixers. In one embodiment, the material for the micro-capsule or nano-capsule is added to an aqueous solution containing a biocide or non-biocidal agent and forms a vesicle containing the biocide or non-biocidal agent.

In one embodiment, the micro-capsule or nano-capsule forms a bilayer or multilayer vesicle. For example, the biocide or non-biocidal agent may be encapsulated within other materials by known encapsulation processes, so as to have one or more protective outer layers that define the micro-capsule or nano-capsule lifetime, delivery characteristics and use environment. In one embodiment, the biocide or non-biocidal agent is within the aqueous core of the micro-capsule or nano-capsule. In another embodiment, the biocide or non-biocidal agent may be injected into the micro-capsule or nano-capsule and carried in one of the layers of the micro-capsule or nano-capsule.

The active protozoa, the trophozoite stage, grazes on the micro-capsules or nano-capsules, mistaking them for bacteria cells. Once engulfed or phagocitized by the protozoa, the natural enzymatic breakdown of the biocide- or non-biocidal agent-containing micro-capsule or nano-capsule by the protozoa would result in the release of the biocide or non-biocidal agent in high concentration in the protozoa. If the protozoa contained engulfed pathogens, such as Legionella, the release of the biocide or non-biocidal agent would be in direct proximity to the engulfed pathogen and rapid death of the pathogen, such as Legionella, would then proceed. This method would also inactivate the host protozoa by the biocide or non-biocidal agent, such as by destroying it or preventing it from spreading or reproducing. In the event that the protozoa are already in the cyst stage, the addition of micro-capsules or nano-capsules prepared with bacterial cell size and suitable membrane characteristics would induce the cysts to excyst or revert to active trophozoite stage in order to take advantage of the new food source. At that point, grazing and engulfing of the micro-capsules or nano-capsules by the protozoa would then occur.

The benign surface structure of the micro-capsule or nano-capsule is additionally advantageous in that, unlike a traditional control agent, it should not induce cyst formation, creating more barriers to treatment. In general, the ability of encapsulated biocides or non-biocidal agents to specifically be taken up by and target the protozoa, is expected to allow a relatively low concentration of treatment material to be added to an aqueous system and yet be more highly effective than the use of a free biocide or non-biocidal agent, whose efficacy depends on its level in the fluid as a whole.

The biocide may be any type of biocide that is suitable for killing or destroying the protozoa and any engulfed pathogens. In one embodiment, the biocide may be a non-oxidizing, oxidizing or molluscicide antimicrobial compounds, or combinations thereof. In another embodiment, the biocide includes, but is not limited to, guanidine or biguanidine salts, quaternary ammonium salts, phosphonium salts, 2-bromo-2-nitropropane-1,3-diol, 5-chloro-2-methyl-4-isothiazolin-3-one/2-methyl-4-isothiazolin-3-one, n-alkyl-dimethylbenzylammonium chloride, 2,2, dibromo-3-nitrilopropionamidemethylene-bis(thiocyanate), dodecylguanidine hydrochloride, glutaraldehyde, 2-(tert-butylamino)-4-chloro-6-(ethylamino)-s-triazine, beta-bromonitrostyrene, tributyltinoxide n-tributyltetradecyl phosphonium chloride, tetrahydroxymethyl phosphonium chloride, 4,5,-dichloro-1,2,-dithiol-3-one, sodium dimethyldithiocarbamate, disodium ethylenebisdithiocarbamate, Bis(trichloromethyl) sulfone, 3,5-dimethyl-tetrahydro-2H-1,3,5,-thiadiazine-2-thione, 1,2,-benzisothiazolin-3-one, decylthioethylamine hydrochloride, copper sulfate, silver nitrate, bromochlorodimethylhydantoin, sodium bromide, dichlorodimethylhydantoin, sodium hypochlorite, hydrogen peroxide, chlorine dioxide, sodium chlorite, bromine chloride, peracetic acid and precursors, sodium trichloroisocyanurate, sodium trichloroisocyanurate, dibromo, dicyano butane and combinations thereof.

In one embodiment, the biocide may be guanidine or biguanidine salts; quaternary ammonium salts and phosphonium salts. Examples of guanidine or biguanidine salts are of the general formulas:

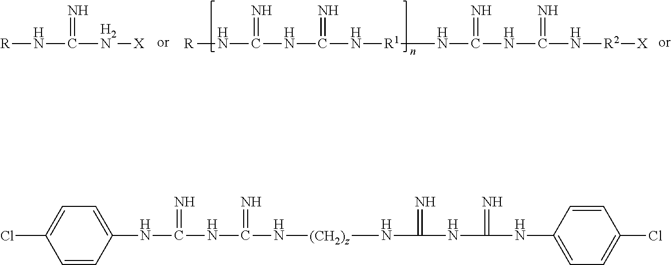

wherein R, R¹, R² are independently H, C₁-C₂₀ substituted or non-substituted alkyl (linear or branched) or aryl, X is an organic or inorganic acid, n is 0-20 and z is 1-12.

Examples of the general formula of acceptable phosphonium salts comprises (R₁)₃P⁺R₂.X⁻ wherein R₁, is an alkyl group of from 1 to 8 carbon atoms, R₂ is an n-alkyl group giving 8 to 20 carbon atoms and X is an anion consisting of a halide, sulfate, nitrate, nitrite, and combinations thereof.

An alternative formula provides that R₁ is an alkyl group having from 1-8 carbons, R₂ is an n-alkyl group having 6-20 carbon groups and X⁻ is an anion such as halides, sulfates, nitrates, nitrites and mixtures thereof. Preferably, X⁻ is chloride, bromide, iodide, SO₄⁻, and NO₃⁻, NO₂⁻ or mixtures thereof.

Another embodiment provides R1 and R2 are hydroxyalkyl groups having from 1-4 carbons and X⁻ is an anion such as halides, sulfates, nitrates, nitrites and mixtures thereof. Preferably, X⁻ is chloride, bromide, iodide, SO₄⁻, and NO3⁻, NO2⁻ or mixtures thereof.

Quaternary ammonium salts are another example of a biocide or agent that may be encapsulated or manufactured into a liposome core, and are of the general formula R₁R₂R₃N⁺—CH₂-benzyl ring X⁻.

wherein R₁ is an n-alkyl group of chain length C₈-C₁₈; R₂ and R₃ are CH₃ or n-alkyl group of chain length C₂-C₈ and X⁻ is an anion such as halides, sulfates, nitrates, nitrites and mixtures thereof.

The non-biocidal agents may be any type of environmentally friendly compound or composition that removes or inactivates the protozoa to keep it from spreading, such as by interfering with its life or reproductive cycle. In one embodiment, the non-biocidal agent may be used as an adjuvant with a biocide. For example, non-biocidal agents include, but are not limited to, biodispersants, ethylene oxide/propylene oxide copolymers, trichlorohexanoic acid, polysiloxanes, carbosilanes, polyethyleneimine, bacteria, microorganisms, plasmids, phagocytes, macrophages, toxin-producing microorganisms, amino acids, proteins, peptides, DNA, RNA, base pairs, antisense RNA pharmaceuticals, antibiotics, chelators, natural extracts, organic/inorganic redox agents, organic and inorganic dye sensitizers, apoptosis signaling reagent, microorganism- and plant-derived extracts and by-products, metabolic components, preservatives, toxic phytochemicals, microbial toxins, catalysts that generate free radicals or active oxygen species, L-cystin and enzymes or combinations thereof.

Additives may be added with the biocide or non-biocidal agent as desired. In one embodiment, a stabilizer may be added to the biocide or non-biocidal agent.

The biocide or non-biocidal agent may be incorporated into the micro-capsule or nano-capsule in any amount sufficient for controlling the protozoa and will depend on the specific biocide or non-biocidal agent. In one embodiment, the biocide or non-biocidal agent is incorporated into a micro-capsule or nano-capsule in an amount of from about 0.05 to about 5 grams biocide or non-biocidal agent active per gram of material for the micro-capsule or nano-capsule. In another embodiment, the biocide or non-biocidal agent is present from about 0.1 to about 2.0 grams biocide or non-biocidal agent active per gram of material for the micro-capsule or nano-capsule.

The micro-capsule or nano-capsule containing the biocide or non-biocidal agent is introduced to the aqueous system to control the protozoa. The micro-capsule or nano-capsule may be added in any manner to the aqueous system. In one embodiment, the micro-capsules or nano-capsules are added to the aqueous system in effective amounts, such that the amount of the biocide or non-biocidal agent is introduced into the aqueous system from about 0.05 to about 500 micrograms per milliliter. In another embodiment, the microcapsules or nano-capsules are added to the aqueous system such that the amount of the biocide or non-biocidal agent is introduced into the aqueous system from about 0.1 to about 100 micrograms per milliliter. In another embodiment, the microcapsule or nano-capsule or is added to the aqueous system in an amount of from about 0.01 ppm by volume to about 100 ppm by volume. In another embodiment, the micro-capsule or Liposome is added to the aqueous system in an amount of from about 0.01 ppm by volume to about 50 ppm by volume. In another embodiment, the micro-capsule or nano-capsule is added in an amount of from about 0.01 ppm by volume to about 20 ppm by volume. In another embodiment, the micro-capsule or nano-capsule is added to the aqueous system in an amount of from about 0.05 ppm by volume to about 5.0 ppm by volume.

The aqueous system may be any type of aqueous system containing protozoa. In one embodiment, the aqueous system includes, but is not limited to, potable and non-potable water distribution systems, cooling towers, boiler systems, showers, aquaria, sprinklers, spas, cleaning baths, air washers, pasteurizers, air conditioners, fluid transporting pipelines, storage tanks, ion exchange resins, food and beverage processing lines, metalworking fluid baths, coal and mineral slurries, metal leaching fluids, wastewater treatment facilities, mollusk control or acid mine drainage.

An alternate or further embodiment provides that the micro-capsule or nano-capsule is a liposome. Liposomes are structures that enclose a volume, such as a biocide or non-biocidal agent, and contain lipids and water. It is manufactured such that a biocide or non-biocidal agent is contained within an aqueous liposome core or trapped within hydrophobic lipid layers. In one embodiment, the lipid may be a phospholipid, lethicin, phosphatidyl choline, glycolipid, triglyceride, sterol, fatty acid, sphingolipid, or combinations thereof.

Liposomes can be manufactured by any known process, including, but not limited to, controlled evaporation, extrusion (for example, pressure extrusion of an aqueous biocide or non-biocidal agent through a porous membrane into the lipid body or vice-versa), such as pressure extrusion of an aqueous control agent through a porous membrane into the lipid body, injection, sonication, microfluid processors and rotor-stator mixers. In one embodiment, lipids are added to an aqueous buffer solution containing a biocide or non-biocidal agent and mixed to form a liposome vesicle containing a biocide or non-biocidal agent. The lipids can arrange themselves into a bilayer or multilayer microscopic vesicle, very similar to a cell membrane, surrounding an aqueous volume core containing a biocide or non-biocidal agent. In one embodiment, the biocide or non-biocidal agent is within the aqueous core of the liposome. In another embodiment, the biocide or non-biocidal agent may be injected into the liposome and carried in one of the lipid layers.

The liposomes may be the encapsulating bodies containing the biocide or non-biocidal agent, or such a biocide- or non-biocidal agent-containing liposomes may themselves be further encapsulated, e.g., by a thin shell of protective material. In the latter case, the shell may, for example, be compounded to provide a further, temporary protective cover for the liposome, such as a degradable skin, that enhances the lifetime of the liposome in the water system yet dissolves, decays or otherwise breaks down after a certain time, or under certain conditions, releasing the liposomes which may then act on the target organisms.

The biocide- or non-biocidal agent-containing liposomes can be produced in sizes that mimic bacterial cells. In one embodiment, the liposomes have a size of from about 0.01 micron to about 100 microns. In another embodiment, the liposomes may be from about 0.01 micron to about 50 microns. In another embodiment, the liposomes have a size of from about 0.01 micron to about 20 microns. In another embodiment, the liposome has a size of from about 0.05 micron to about 15 microns. In another embodiment, the liposomes have a size of from about 0.1 micron to about 10 microns. In another embodiment, the liposomes have a size of from about 0.1 micron to about 2 microns. The size of the micro-capsules or nano-capsules is measured directly by microscopic techniques.

The biocide or non-biocidal agent may be incorporated into the liposome in any amount sufficient for controlling the protozoa and will depend on the specific biocide or non-biocidal agent. In one embodiment, the biocide or non-biocidal agent is incorporated into a liposome in an amount of from about 0.05 to about 5 grams biocide or non-biocidal agent active per gram lipid. In another embodiment, the biocide or non-biocidal agent is present from about 0.1 to about 2.0 grams biocide or non-biocidal agent active per gram lipid.

The liposome containing the biocide or non-biocidal agent is introduced to the aqueous system to control the protozoa. The liposome may be added in any manner to the aqueous system. In one embodiment, the liposomes are added to the aqueous system in effective amounts, such that the amount of the biocide or non-biocidal agent is introduced into the aqueous system from about 0.05 to about 500 micrograms per milliliter. In another embodiment, the liposomes are added to the aqueous system such that the amount of the biocide or non-biocidal agent is introduced into the aqueous system from about 0.1 to about 100 micrograms per milliliter. In another embodiment, the liposome is added to the aqueous system in an amount of from about 0.01 ppm by volume to about 100 ppm by volume. In another embodiment, the liposome is added to the aqueous system in an amount of from about 0.01 by volume to about 50 ppm by volume. In another embodiment, the liposome is added in an amount of from about 0.01 ppm by volume to about 20 ppm by volume. In another embodiment, the liposome is added to the aqueous system in an amount of from about 0.05 ppm by volume to about 5.0 ppm by volume.

In one embodiment, a vesicle for controlling protozoa trophozoites and cysts, wherein said vesicle contains an exterior composition adapted for digestion by said protozoa and one or more biocides or non-biocidal agents, wherein the biocides or non-biocidal agents are encapsulated within the vesicle and said vesicle is selected from the group consisting of micro-capsules, nano-capsules and liposomes.

The vesicles may be added in an aqueous system to control protozoa, such as by reducing, removing or inactivating the protozoa and contain the protozoa from spreading. The protozoa types and its stages are described above. A biocide or non-biocidal agent for controlling the protozoa is encapsulated into a vesicle. The vesicle contains an exterior composition or material adapted for digestion by the protozoa and a shape to mimic bacteria on which the protozoa feeds. The protozoa are tricked into feeding on the vesicle and engulfing it. As the vesicle is digested, the biocide or non-biocidal agent is released to act on the protozoa. When the protozoa contains pathogens, such as Legionella, the engulfed biocide or non-biocidal agent can act on the protozoa as well as the pathogen inside the protozoa. The vesicle does not cause the protozoa trophozoite to revert to a cyst stage, as it appears benign to the protozoa. Also, any protozoa in cyst form are induced into an active trophozoite form in order to feed on the vesicles.

The vesicle is a type of structure that encloses a volume of biocide or non-biocidal agent and is for delivering the biocide or non-biocidal agent to the protozoa trophozoites or cysts. The vesicle may be a micro-capsule, a nano-capsule or a liposome, which are described above. The biocide or non-biocidal agent encapsulated in the vesicle are also described above.

In one embodiment, the vesicle may have multilayers. In one embodiment, the biocide or non-biocidal agent may be encapsulated within other oil or oil-like phases by known encapsulation processes, so as to have one or more protective outer layers that define the lifetime, delivery characteristics and use environments of the vesicle.

In another embodiment, the micro-capsules, nano-capsules or liposomes can be used in a troubleshooting or proactive measure, by treating non-infected aqueous systems to be ready to attack as soon as infected protozoa begin to appear in infective numbers.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A method for controlling protozoa trophozoites and cysts wherein one or more biocides or non-biocidal agents are encapsulated within a microcapsule or nano-capsule having an exterior composition adapted for digestion by said protozoa and then introduced into an aqueous system.

2. The method of claim 1 wherein said micro-capsule or nano-capsule comprises a material selected from the group consisting of lecithin, gum, gel, biodegradable or non-biodegradable polymers, organic polymers and multi-block polymers.

3. The method of claim 1 wherein said micro-capsule or nano-capsule has multiple layers.

4. The method of claim 3, wherein the micro-capsule or nano-capsule contains one or more protective outer layers.

5. The method of claim 1 wherein said protozoa contain Legionella type bacteria.

6. The method of claim 1 wherein the biocide is selected from the group consisting of non-oxidizing biocides, oxidizing biocides, molluscicide antimicrobial compounds, and combinations thereof.

7. The method of claim 1 wherein the microcapsules are produced and applied in sizes from about 0.01 micron to about 100 microns.

8. The method of claim 6 wherein the biocide is chosen from the group consisting of guanidine or biguanidine salts, quaternary ammonium salts, phosphonium salts, 2-bromo-2-nitropropane-1,3-diol, 5-chloro-2-methyl-4-isothiazolin-3-one/2-methyl-4-isothiazolin-3-one, n-alkyl-dimethylbenzylammonium chloride, 2,2, dibromo-3-nitrilopropionamidemethylene-bis(thiocyanate), dodecylguanidine hydrochloride, glutaraldehyde, 2-(tert-butylamino)-4-chloro-6-(ethylamino)-s-triazine, beta-bromonitrostyrene, tributyltinoxide, n-tributyltetradecyl phosphonium chloride, tetrahydroxymethyl phosphonium chloride, 4,5,-dichloro-1,2,-dithiol-3-one, sodium dimethyldithiocarbamate, disodium ethylenebisdithiocarbamate, Bis(trichloromethyl) sulfone, 3,5-dimethyl-tetrahydro-2H-1,3,5,-thiadiazine-2-thione, 1,2,-benzisothiazolin-3-one, decylthioethylamine hydrochloride, copper sulfate, silver nitrate, bromochlorodimethylhydantoin, sodium bromide, dichlorodimethylhydantoin, sodium hypochlorite, hydrogen peroxide, chlorine dioxide, sodium chlorite, bromine chloride, peracetic acid and precursors, sodium trichloroisocyanurate, sodium trichloroisocyanurate, dibromo, dicyano butane and combinations thereof.

9. The method of claim 1 wherein the effective amount of the biocide or non-biocidal agent introduced into the aqueous system is from about 0.05 to about 500 micrograms per milliliter.

10. The method of claim 1 wherein the aqueous system is chosen from the group consisting of potable and non-potable water distribution systems, cooling towers, showers, aquaria, sprinklers, spas, pipelines, cleaning baths, air washers, pasteurizers, air conditioners, fluid transporting pipelines, storage tanks, ion exchange resins, food and beverage processing lines, metalworking fluid baths, coal and mineral slurries, metal leaching fluids, wastewater treatment facilities, mollusk control and acid mine drainage.

11. The method of claim 1 wherein the non-biocidal agent is selected from the group consisting of biodispersants, bacteria, microorganisms, plasmids, phagocytes, macrophages, toxin-producing microorganisms, amino acids, proteins, peptides, DNA, RNA, base pairs, antisense RNA pharmaceuticals, antiobiotics, chelators, natural extracts, organic/inorganic redox agents, organic and inorganic dye sensitizers, apoptosis signaling reagent, microorganism- and plant-derived extracts and by-products, metabolic components, preservatives, toxic phytochemicals, microbial toxins, catalysts that generate free radicals or active oxygen species, L-cystin, enzymes and combinations thereof.

12. The method of claim 11 wherein the biodispersant is selected from the group consisting of ethylene oxide/propylene oxide copolymers, trichlorohexanoic acid, polysiloxanes, carbosilanes, polyethyleneimine or combinations thereof.

13. The method of claim 1 wherein the micro-capsule or nano-capsule is a liposome.

14. The method of claim 13 wherein said liposome comprises a lipid

15. The method of claim 14, wherein the lipid is selected from the'group consisting of phospholipids, lethicin, phosphatidyl choline, glycolipids, triglyceride, sterol, fatty acids, sphingolipid, and combinations thereof.

16. The method of claim 13 wherein said liposome has multiple layers.

17. The method of claim 16, wherein the liposome contains one or more protective outer layers.

18. The method of claim 13 wherein the control agent is a biocide is selected from the group consisting of non-oxidizing biocides, oxidizing biocides, molluscicide antimicrobial compounds, and combinations thereof.

19. The method of claim 18 wherein the biocide is chosen from the group consisting of guanidine or biguanidine salts, quaternary ammonium salts, phosphonium salts, 2-bromo-2-nitropropane-1,3-diol, 5-chloro-2-methyl-4-isothiazolin-3-one/2-methyl-4-n-alkyl-dimethylbenzylammonium chloride, 2,2, dibromo-3-nitrilopropionamidemethylene-bis(thiocyanate), dodecylguanidine hydrochloride, glutaraldehyde, 2-(tert-butylamino)-4-chloro-6-(ethylamino)-s-triazine, beta-bromonitrostyrene, tributyltinoxide, n-tributyltetradecyl phosphonium chloride, tetrahydroxymethyl phosphonium chloride, 4,5,-dichloro-1,2,-dithiol-3-one, sodium dimethyldithiocarbamate, disodium ethylenebisdithiocarbamate, Bis(trichloromethyl) sulfone, 3,5-dimethyl-tetrahydro-2H-1,3,5,-thiadiazine-2-thione, 1,2,-benzisothiazolin-3-one, decylthioethylamine hydrochloride, copper sulfate, silver nitrate, bromochlorodimethylhydantoin, sodium bromide, dichlorodimethylhydantoin, sodium hypochlorite, hydrogen peroxide, chlorine dioxide, sodium chlorite, bromine chloride, peracetic acid and precursors, sodium trichloroisocyanurate, sodium trichloroisocyanurate, dibromo, dicyano butane and combinations thereof.

20. The method of claim 13 wherein the liposomes are produced and applied in diameter sizes from about 0.01 micron to about 100 microns.

21. The method of claim 13 wherein the non-biocidal agent is selected from the group consisting of biodispersants, bacteria, microorganisms, plasmids, phagocytes, macrophages, toxin-producing microorganisms, amino acids, proteins, peptides, DNA, RNA, base pairs, antisense RNA pharmaceuticals, antiobiotics, chelators, natural extracts, organic/inorganic redox agents, organic and inorganic dye sensitizers, apoptosis signaling reagent, microorganism- and plant-derived extracts and by-products, metabolic components, preservatives, toxic phytochemicals, microbial toxins, catalysts that generate free radicals or active oxygen species, L-cystin, enzymes and combinations thereof.

22. The method of claim 21 wherein the biodispersant is selected from the group consisting of ethylene oxide/propylene oxide copolymers, trichlorohexanoic acid, polysiloxanes, carbosilanes, polyethyleneimine or combinations thereof.

23. A vesicle for controlling protozoa trophozoites and cysts, wherein said vesicle contains an exterior composition adapted for digestion by said protozoa and one or more biocides or non-biocidal agents, wherein the biocides or non-biocidal agents are encapsulated within the vesicle and said vesicle is selected from the group consisting of micro-capsules, nano-capsules and liposomes.

24. The vesicle of claim 23 wherein the vesicle has multiple layers.

25. The vesicle of claim 24, wherein the vesicle contains one or more protective outer layers.

26. The vesicle of claim 23 wherein the biocide is selected from the group consisting of non-oxidizing biocides, oxidizing biocides, molluscicide antimicrobial compounds, and combinations thereof.

27. The vesicle of claim 23 wherein the vesicle has a size of from about 0.01 micron to about 100 microns.

28. The vesicle of claim 26 wherein the biocide is chosen from the group consisting of guanidine or biguanidine salts, quaternary ammonium salts, phosphonium salts, 2-bromo-2-nitropropane-1,3-diol, 5-chloro-2-methyl-4-isothiazolin-3-one/2-methyl-4-isothiazolin-3-one, n-alkyl-dimethylbenzylammonium chloride, 2,2, dibromo-3-nitrilopropionamidemethylene-bis(thiocyanate), dodecylguanidine hydrochloride, glutaraldehyde, 2-(tert-butylamino)-4-chloro-6-(ethylamino)-s-triazine, beta-bromonitrostyrene, tributyltinoxide, n-tributyltetradecyl phosphonium chloride, tetrahydroxymethyl phosphonium chloride, 4,5,-dichloro-1,2,-dithiol-3-one, sodium dimethyl dithiocarbamate, disodium ethylenebisdithiocarbamate, Bis(trichloromethyl) sulfone, 3,5-dimethyl-tetrahydro-2H-1,3,5,-thiadiazine-2-thione, 1,2,-benzisothiazolin-3-one, decylthioethylamine hydrochloride, copper sulfate, silver nitrate, bromochlorodimethylhydantoin, sodium bromide, dichlorodimethylhydantoin, sodium hypochlorite, hydrogen peroxide, chlorine dioxide, sodium chlorite, bromine chloride, peracetic acid and precursors, sodium trichloroisocyanurate, sodium trichloroisocyanurate, dibromo, dicyano butane and combinations thereof.

29. The vesicle of claim 23 wherein the non-biocidal agent is selected from the group consisting of biodispersants, bacteria, microorganisms, plasmids, phagocytes, macrophages, toxin-producing microorganisms, amino acids, proteins, peptides, DNA, RNA, base pairs, antisense RNA pharmaceuticals, antiobiotics, chelators, natural extracts, organic/inorganic redox agents, organic and inorganic dye sensitizers, apoptosis signaling reagent, microorganism- and plant-derived extracts and by-products, metabolic components, preservatives, toxic phytochemicals, microbial toxins, catalysts that generate free radicals or active oxygen species, L-cystin, enzymes and combinations thereof.

30. The vesicle of claim 29 wherein the biodispersant is selected from the group consisting of ethylene oxide/propylene oxide copolymers, trichlorohexanoic acid, polysiloxanes, carbosilanes, polyethyleneimine or combinations thereof.
